(19) United States
(12) Patent Application Publication
(10) Pub. No.: US 2014/0008145 A1
(43) Pub. Date: Jan. 9, 2014

(54) SOUND ABSORBING AND INSULATION COMPOSITION MATERIAL COMPOSITION

(71) Applicants: Mingyang Lin, Tainan City (CN); Kuoliang Pan, Tainan City (CN)

(72) Inventors: Mingyang Lin, Tainan City (CN); Kuoliang Pan, Tainan City (CN)

(73) Assignee: SAN SHANG TECHNOLOGY CO., LTD., Tainan City (CN)

(21) Appl. No.: 14/006,134

(22) PCT Filed: Mar. 22, 2011
(86) PCT No.: PCT/CN11/00481

§ 371 Date: Sep. 19, 2013

(51) Int. Cl. B32B 27/00

(52) U.S. Cl. CPC B32B 27/00
USPC 181/294

(57) ABSTRACT

The present invention discloses a sound absorbing and insulating composite material composition formed by attaching at least one non-woven fiber layer and at least one polyethylene film closely with each other, and the non-woven fiber layer is a stacked fiber layer made of a renewable green fiber material and manufactured by the non-woven fabric manufacturing method, and the non-woven fiber layer has a thickness equal to or greater than 1 mm, and the polyethylene film has a thickness from 0.009 mm to 0.1 mm.

### BACKGROUND OF THE INVENTION

1. Field of the Invention

The present invention relates to a sound absorbing and insulating composite material composition, in particular to a composite material made of a renewable green fiber material and formed by attaching at least one non-woven fiber layer and at least one polyethylene film closely with each other, and capable of providing excellent sound absorbing and insulating effects.

2. Description of the Related Art

In our daily life, sound absorbing and/or sound insulating effects are commonly used. For example, the sound absorbing and insulating effects are used extensively in luxury cars for a comfortable ride and a good sound effect, so that it is necessary to utilize materials with good sound absorbing and insulating effects in order to insulate and absorb external high-frequency noises and sounds as well as the low-frequency noises and resonance produced by the car while it is traveling. If the sound absorbing and sound insulating effects are poor, it is difficult to show the value of the luxury cars, and thus the sound absorbing and insulating materials used for the interior design of the cars has significant and substantial impacts on the sound absorbing and insulating performance. Nowadays, people are living closely with others, so that it is necessary to enhance the sound absorbing and insulating effects of the household environment. For example, the sound absorbing and insulating effects of a stereo room is required if the stereo room with KTV stereo is set up in a house, so as to provide a good entertainment effect without disturbing neighbors and losing a friendship. In addition, to insulate external noises (such as the sound of traveling cars on a road, the sharp sound of a sudden siren, the crying sound of neighborhood children, the operating sound of nearby air-conditioners, and the noisy sounds of KTV of neighbors) from a home, so that it is necessary to select a good sound absorbing and/or sound insulating material for the construction material or fill the gaps of doors and windows, indicating that people pay more attention to the sound absorbing and insulating effects than ever.

The definition of “sound absorption” is different from the definition of “sound insulation”, and the “sound absorption” refers to the process from reduction to elimination of sound, whose principle is to allow a sound absorbing material to receive an incoming sound wave, such that the energy of the sound wave can promote the vibration of elastic fibers in the sound absorbing material or the collision of air molecules to produce friction in bores of the material, so as to diminish the mechanical energy and convert the energy of the vibrated sound waves to reduce the amplitude of the sound wave and decrease the sound volume. On the other hand, the “sound insulation” emphasizes on isolating a sound reflection or refraction to the outside of a receiving end in order to achieve the effect of an escape. Therefore, the operating principles and using effects of the sound absorption and the sound insulation are different. To enhance the sound absorbing effect, the sound wave should be able to penetrate into the sound absorbing material easily, so that the sound wave can be deteriorated inside the sound absorbing material. To enhance the sound insulating effect, the sound wave penetrating into the sound absorbing material should be reduced, in order to isolate the sound wave. However, the aforementioned two mechanisms have conflicts, such that it is difficult for a same material to achieve both sound absorbing and insulating effects concurrently, and it is necessary to adopt a multilayer design for the application to achieve a better sound absorbing and insulating effects.

In general, the sounds occurred in our daily life is mainly divided into high-frequency, mid-frequency and low-frequency sounds, wherein the high- and mid-frequency sounds have a high frequency and a small amplitude, so that the sound is relatively sharper and more intolerable, and thus it is a first priority for related manufacturers and designers to find a sound absorbing material capable of absorbing the high- and mid-frequency sounds quickly. Among various different types of sound absorbing materials, some sound absorbing materials are good at absorbing high-frequency sounds but poor at absorbing mid-frequency sounds and have an easily deteriorated sound absorbing capability. On the other hand, some sound absorbing materials emphasizes on absorbing mid-frequency sounds, but poor at absorbing high-frequency sounds or even cannot absorb high-frequency sounds. In summation, it is still difficult to find a material or a composite material having a good sound absorbing effect for both high- and mid-frequency sounds. Therefore, the wavelength and the frequency of the sound wave are reversely proportional to each other. Theoretically, the sound absorbing material can achieve a complete sound absorbing effect only if the thickness is equal to or greater than one-quarter of the wavelength (or amplitude) of the sound wave. For the mid- and low-frequency noises with a greater wavelength, if the ratio of thickness to wavelength of the material is small, then the energy of the sound wave of the mid- and low-frequency sounds can be passed across the material directly, and will be difficult to be deteriorated inside the sound absorbing material. Therefore, the absorption of mid- and low-frequency sound waves cannot rely on the deterioration mechanism inside the sound absorbing material for a complete sound absorption of the entered sound wave.

In view of the drawbacks of the prior art, the inventor of the present invention based on years of experience in the field of non-woven fabric material and the development and manufacture of the non-woven fabric material to conduct extensive researches and experiments and attempt to find a good sound absorbing and insulating material among the non-woven fabric material, and finally developed a good sound absorbing and insulating material made of a renewable green material to overcome the drawbacks of the prior art.

### SUMMARY OF THE INVENTION

Therefore, it is a primary objective of the present invention to provide a sound absorbing and insulating composite material composition with good sound absorbing and insulating effects and capable of providing good sound absorbing effect to mid- and high-frequency and mid- and low-frequency sounds.

The present invention is characterized in that both physical sound insulating and sound absorbing mechanisms are combined effectively, wherein a surface layer with a high damper property is created at the surface of the sound absorbing material surface, such that before the sound wave enters into the sound absorbing material, the energy is deteriorated on the surface layer of the material, such that an energy deterioration can be achieved more easily when the sound wave enters into the material. For simplicity and easy understanding, the operating principle of the present invention adopts another object for the illustration. For example, a table tennis ball is used for demonstration the molecular transmission of the sound wave. When the table tennis ball hits at a material with a relatively harder surface layer such as a wall or an elastic surface, an obvious bounce will occur. In other words, the sound wave is reflected, thus providing a good sound insulating effect, but a poor sound absorbing effect. On the other hand, if the table tennis ball hits a material with a surface layer having a high damping coefficient and a low elasticity such as a fabric net or mud, then most of the collision energy of the table tennis ball will be absorbed by the surface layer, and the bouncing force will become smaller. Therefore, even though the sound wave (table tennis ball) has not entered into the material, yet the energy has been deteriorated at the surface of the sound absorbing material, and the sound wave will not be reflected. The present invention adopts such principle to create the material with good sound absorbing and insulating effects, and the present invention further increases the width of the material, such that the material will not be affected by wavelength and frequency related mechanisms or limited by a poor low-frequency effect. As a result, the present invention can provide good sound absorbing and insulating effects within a wider range of frequencies.

To achieve the foregoing objectives, the present invention provides a sound absorbing and insulating composite material composition formed by attaching at least one non-woven fiber layer and at least one polyethylene film closely, wherein the non-woven fiber layer is a stacked fiber layer manufactured by a non-woven fabric manufacturing method and has a thickness equal to or greater than 1 mm, and the polyethylene film has a thickness from 0.009 mm to 0.1 mm; the surface of the polyethylene film is unfavorable for passing sound waves and air molecules, and it can intercept air molecules. Since the thickness is very thin, the elasticity becomes lower, and the damping effect occurs for absorbing the sound wave, such that if the energy of the sound wave reaches the surface of the polyethylene film, the energy is deteriorated to a certain level, such that when remaining sound waves pass through the polyethylene film and enter into the non-woven fiber layer, the elastic vibration of fibers and the friction produced by molecular collisions between gaps of the fibers, the mechanical energy of the sound wave will be further deteriorated, so as to achieve the good sound insulating and absorbing effects.

The sound absorbing and insulating composite material composition is formed by attaching a non-woven fiber layer and a polyethylene film closely, wherein the non-woven fiber layer is a stacked fiber layer manufactured by a non-woven fabric manufacturing method and has a thickness equal to or greater than 1 mm, and the polyethylene film has a thickness from 0.009 mm to 0.1 mm.

The sound absorbing and insulating composite material composition further comprises a second polyethylene film attached flatly and closely onto a surface of the non-woven fiber layer, and the second polyethylene film has a thickness from 0.009 mm to 0.1 mm.

The sound absorbing and insulating composite material composition further comprises a second non-woven fiber layer attached flatly and closely onto a surface of the second polyethylene film, and the second non-woven fiber layer is a stacked fiber layer manufactured by a non-woven fabric manufacturing method and has a thickness equal to or greater than 1 mm.

The sound absorbing and insulating composite material composition further comprises a third polyethylene film attached flatly and closely onto a surface of the second non-woven fiber layer, and the third polyethylene film has a thickness from 0.009 mm to 0.1 mm.

The sound absorbing and insulating composite material composition further comprises a third non-woven fiber layer attached flatly and closely onto a surface of the third polyethylene film, and the third non-woven fiber layer is a stacked fiber layer manufactured by a non-woven fabric manufacturing method and has a thickness equal to or greater than 1 mm.

The sound absorbing and insulating composite material composition further comprises a fourth polyethylene film attached flatly and closely onto a surface of the third non-woven fiber layer, and the fourth polyethylene film has a thickness from 0.009 mm to 0.1 mm.

### BRIEF DESCRIPTION OF THE DRAWINGS

FIG. 1 is a schematic view of a “single-layer single-attachment configuration” in accordance with a first preferred embodiment of the present invention;

FIG. 2 is a schematic view of a “single-layer double-attachment configuration” in accordance with a second preferred embodiment of the present invention;

FIG. 3 is a schematic view of a “double-layer single-attachment configuration” in accordance with a third preferred embodiment of the present invention;

FIG. 4 is a schematic view of a “double-layer double-attachment configuration” in accordance with a fourth preferred embodiment of the present invention;

FIG. 5 is a schematic view of a “triple-layer single-attachment configuration” in accordance with a fifth preferred embodiment of the present invention; and

FIG. 6 is a schematic view of a “triple-layer double-attachment configuration” in accordance with a fifth preferred embodiment of the present invention.

Attachment: A copy of test report of the present invention

### DETAILED DESCRIPTION OF THE PREFERRED EMBODIMENTS

To make it easier for our examiner to understand the technical characteristics and measures of the present invention to achieve the aforementioned objects and effects, we use preferred embodiments with related drawings for the detailed description of the present invention as follows.

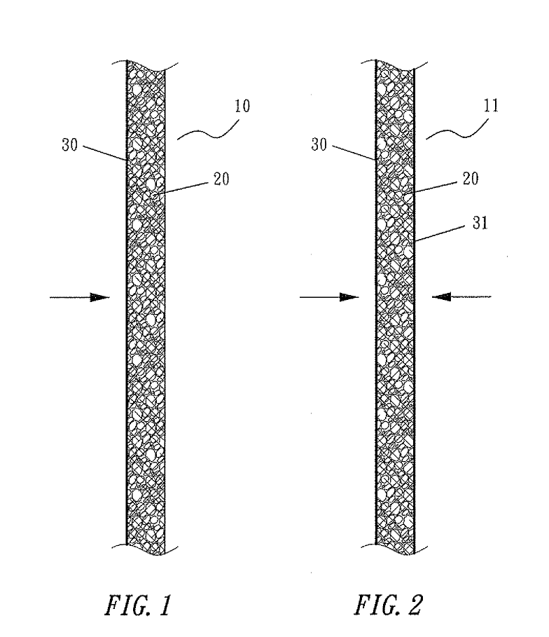

With reference to FIG. 1 for a sound absorbing and insulating composite material 10 in accordance with a first preferred embodiment of the present invention, the sound absorbing and insulating composite material 10 is basically formed by attaching at least one non-woven fiber layer 20 and at least one polyethylene film 30 (Polyethylene, PE) tightly. FIG. 1 is a schematic view showing the structure of the sound absorbing and insulating composite material 10 which is formed by attaching a non-woven fiber layer 20 and a polyethylene film 30 tightly with each other, and this structure is called a “single-layer single-attachment configuration”. Wherein, the non-woven fiber layer 20 is a stacked fiber layer manufactured by a non-woven fabric manufacturing method and made of a renewable green fiber material to achieve the energy-saving and carbon reduction effects. However, the non-woven fiber layer 20 can be made of any other fiber material, and it has a thickness equal to or greater than 1 mm for supporting one (at least one) stacked fiber layer formed by a plurality of fibers intersected with each other and having a plurality of interlaced 3D spaces, and the polyethylene film 30 has a thickness from 0.009 mm to 0.1 mm. During assembling, the non-woven fiber layer 20 and the polyethylene film 30 should have substantially equal areas to facilitate attaching the polyethylene film 30 onto a surface of the non-woven fiber layer 20 flatly and closely, and an appropriate method is used for coupling the polyethylene film 30 and the non-woven fiber layer 20 closely together. For example, a frame can be used for tightening the periphery of the polyethylene film 30 and the non-woven fiber layer 20 for the attachment, or a measure such as laminating, sintering, gluing or hot-melt bonding is taken to attach the polyethylene film 30 onto a surface of the non-woven fiber layer 20 closely.

During installation and use, the polyethylene film 30 of the sound absorbing and insulating composite material 10 is aligned towards the sound entering direction, such that when air molecules for transmitting the energy of sound waves are in contact with the polyethylene film 30, the energy will be stopped and absorbed by the surface of the polyethylene film 30 first, so that only a portion of energies will pass through the polyethylene film 30 and enter into the non-woven fiber layer 20, and then the air molecules are reflected, refracted, and collided in the plurality of interlaced 3D spaces inside the non-woven fiber layer 20, such that the plurality of fibers of the non-woven fiber layer 20 can initiate a series of energy consumptions by frictions, and the energy of the sound wave energy is converted into frictional heat once again to cause a substantial deterioration of energy of the sound wave. As a result, the sound wave cannot pass through the polyethylene film 30, and a high-performance sound absorbing effect can be achieved. Obviously, the use of the sound absorbing and insulating composite material 10 in accordance with the first preferred embodiment of the present invention can provide a high performance for both sound absorbing and sound insulating effects.

As described above, the sound absorbing and insulating composite material of the present invention is formed by attaching at least one non-woven fiber layer and at least one polyethylene film closely with each other. With reference to FIG. 2 for a sound absorbing and insulating composite material 11 in accordance with a second preferred embodiment of the present invention, a non-woven fiber layer 20, a polyethylene film 30 and a second polyethylene film 31 are attached closely with one another, and the structure is called a “single-layer double-attachment configuration. Wherein, the non-woven fiber layer 20 is a stacked fiber layer manufactured by a non-woven fabric manufacturing method and made of a renewable green fiber material to achieve the energy-saving and carbon reduction effects. However, the non-woven fiber layer 20 can also be made of any fiber material, and has a thickness equal to or greater than 1 mm for supporting one (at least one) stacked fiber layer formed by a plurality of fibers intersected with each other and having a plurality of interlaced 3D spaces, and the polyethylene films 30, 31 have a thickness from 0.009 mm to 0.1. During assembling, the non-woven fiber layer 20 and the polyethylene film 30 should have substantially equal areas to facilitate attaching the polyethylene films 30, 31 onto surfaces of the non-woven fiber layer 20 flatly and closely, and an appropriate method is used for coupling the polyethylene films 30, 31 with the non-woven fiber layer 20 closely together. For example, a frame can be used for tightening the periphery of the three for attachment, or a measure such as laminating, sintering, gluing or hot-melt bonding is taken to attach the polyethylene films 30, 31 onto surfaces of the non-woven fiber layer 20 closely to form the sound absorbing and insulating composite material 11.

During installation and use, the polyethylene films 30, 31 of the sound absorbing and insulating composite material 10 are aligned towards the sound entering direction, such that when air molecules for transmitting the energy of sound waves are in contact with the polyethylene film 30 or the second polyethylene film 31, the energy will be stopped and absorbed by the surfaces of the polyethylene films 30, 31 first, so that only a portion of energies will pass through the polyethylene films 30, 31 and enter into the non-woven fiber layer 20, and then the air molecules are reflected, refracted, and collided in the plurality of interlaced 3D spaces inside the non-woven fiber layer 20, such that the plurality of fibers of the non-woven fiber layer 20 can initiate a series of energy consumptions by frictions, and the energy of the sound wave energy cannot penetrate through the polyethylene films 30, 31, so as to achieve a high-performance sound absorbing effect. Therefore, the sound absorbing and insulating composite material 10 in accordance with the second preferred embodiment of the present invention can achieve the same high-performance sound absorbing and insulating effects as the first preferred embodiment and further provides excellent effects from both lateral sides.

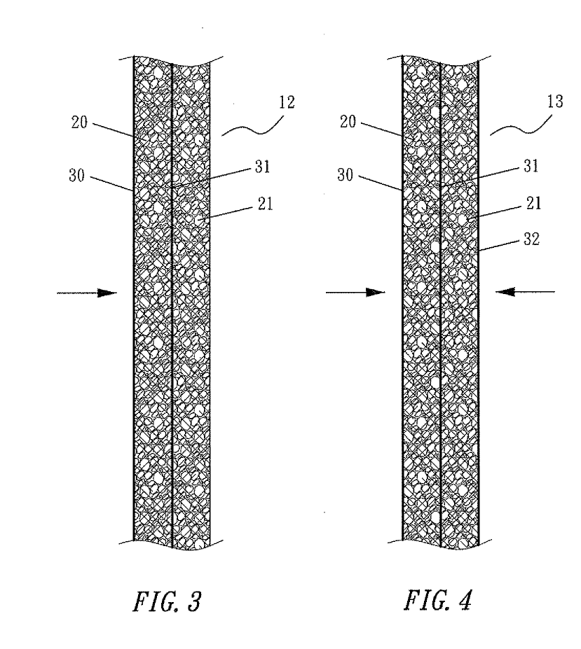

With reference to FIG. 3 for a sound absorbing and insulating composite material 12 in accordance with a third preferred embodiment of the present invention, the sound absorbing and insulating composite material 12 is formed by attaching a polyethylene film 30, a non-woven fiber layer 20, a second polyethylene film 31 and a second non-woven fiber layer 21 closely together, and the structure is called a “double-layer single-attachment configuration”. Wherein, the non-woven fiber layers 20, 21 are a stacked fiber layer manufactured by a non-woven fabric manufacturing method and having a thickness equal to or greater than 1 mm for supporting at least one (which is two in this preferred embodiment) stacked fiber layer made of a plurality of fibers interlaced and intersected with each other and having a plurality of interlaced 3D spaces therein; the polyethylene films 30, 31 have a thickness from 0.009 mm to 0.1 mm. During assembling, the non-woven fiber layers 20, 21 and the polyethylene films 30, 31 should have substantially equal areas to facilitate attaching the polyethylene films 30, 31 onto surfaces of the non-woven fiber layer 20 flatly and closely, and then the second non-woven fiber layer 21 is coupled on another surface of the second polyethylene film 31 flatly and closely. Similarly, an appropriate method is used for coupling the polyethylene film 30, the non-woven fiber layer 20, the second polyethylene film 31 and the second non-woven fiber layer 21. For example, a frame can be used for tightening the periphery of the polyethylene film 30, the non-woven fiber layer 20, the second polyethylene film 31 and the second non-woven fiber layer 21 for attachment, or a measure such as laminating, sintering, gluing or hot-melt bonding is taken to attach the polyethylene films 30, 31 onto surfaces of the non-woven fiber layers 20, 21 closely to form the sound absorbing and insulating composite material 11.

From the comparison of FIGS. 2 and 3, the sound absorbing and insulating composite material 12 of the third preferred embodiment of the present invention further adds a second non-woven fiber layer 21 to the structure of the second preferred embodiment, During installation and use, the polyethylene film 30 is preferably aligned towards the sound entering direction, such that the material 12 has the same high-performance sound absorbing and insulating effects as the first preferred embodiment. If some sound waves with larger energy are not absorbed by the non-woven fiber layer 20 and are penetrated through the second polyethylene film 31 and entered into the second non-woven fiber layer 21, then such sound waves will be handled by the double sound absorbing and insulating effects inside the second non-woven fiber layer 21.

In the structure of the sound absorbing and insulating composite material of the present invention, the structure is formed by attaching at least one non-woven fiber layer and at least one polyethylene film closely with each other, and the third preferred embodiment adds a third polyethylene film 32 attached closely onto an external surface of the second non-woven fiber layer 21 to form the sound absorbing and insulating composite material 13 of the fourth preferred embodiment as shown in FIG. 4, and this structure is called a “double-layer double-attachment configuration”. During installation and use, the polyethylene films 30, 32 on the sound absorbing and insulating composite material 13 are aligned towards the sound entering direction, similarly to the second preferred embodiment, such that the sound wave can enter into the non-woven fiber layer 20 or the second non-woven fiber layer 21 to achieve the high-performance sound absorbing and insulating effects. If some sound waves with large energy are not absorbed by the non-woven fiber layer 20 or second non-woven fiber layer 21 and are penetrated through the second polyethylene film 31 and entered into the second non-woven fiber layer 21 or non-woven fiber layer 20, such sound waves will be handled by the double sound absorbing and insulating effects.

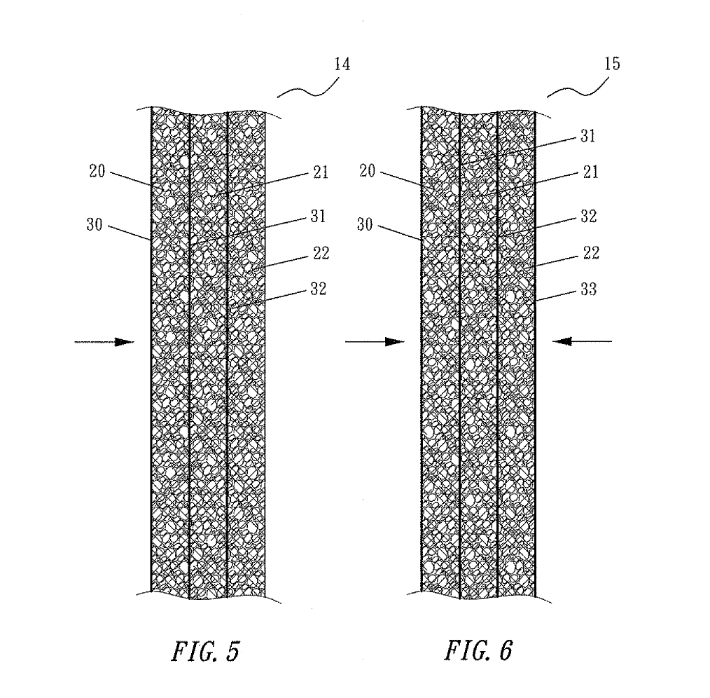

With the same principle of the foregoing preferred embodiments, the fourth preferred embodiment adds a third non-woven fiber layer 22 closely attached onto an external surface of the third polyethylene film 32 to form a sound absorbing and insulating composite material 14 of the fifth preferred embodiment as shown in FIG. 5, and this structure is called a “triple-layer single-attachment configuration” If some sound waves with large energy are not absorbed by the second non-woven fiber layer 21 and are penetrated through the third polyethylene film 32 and entered into the third non-woven fiber layer 22, such sound waves will be handled by the triple sound absorbing and insulating effects. The fifth preferred embodiment adds a fourth polyethylene film 33 closely attached on an external surface of the third non-woven fiber layer 22 to form a sound absorbing and insulating composite material 15 of the sixth preferred embodiment as shown in FIG. 6, and this structure is called a “triple-layer double-attachment configuration” capable of performing the triple sound absorbing and insulating effects to the sound waves continuously to reduce or eliminate the sound waves.

In summation of the description above, the basic structure of the sound absorbing and insulating composite material of the present invention is formed by attaching at least one non-woven fiber layer and at least one polyethylene film closely with each other, wherein the non-woven fiber layer is a stacked fiber layer manufactured by a non-woven fabric manufacturing method and has a thickness equal to or greater than 1 mm, and the polyethylene film has a thickness from 0.009 mm to 0.1 mm. Therefore, the present invention has a basic structure with the single-layer single-attachment configuration formed by attaching a non-woven fiber layer and a polyethylene film closely with each other, and a polyethylene film can be added to another side of the non-woven fiber layer of the basic structure to produce a structure with the single-layer double-attachment configuration. The quantity of non-woven fiber layers and polyethylene films can be increased to produce the structures with the double-layer single-attachment configuration, the double-layer double-attachment configuration, the triple-layer single-attachment configuration or the triple-layer double-attachment configuration. The installation of a sound absorbing and insulating composite material in a particular configuration depends on the sound insulation processing environment and the sound volume. Tests show that the sound absorbing and insulating composite material composition of the present invention provides a good effect, and the testing report is provided for reference.

In summation of the description above, the present invention can achieve the expected objectives and effects, and the invention improves over the prior art and complies with the patent application requirements, and thus is duly applied for patent application.

While the invention has been described by means of specific embodiments, numerous modifications and variations could be made thereto by those skilled in the art without departing from the scope and spirit of the invention set forth in the claims.

What is claimed is:

1. A sound absorbing and insulating composite material composition, formed by attaching at least one non-woven fiber layer and at least one polyethylene film closely, and the non-woven fiber layer being a stacked fiber layer manufactured by a non-woven fabric manufacturing method and having a thickness equal to or greater than 1 mm, and the polyethylene film having a thickness from 0.009 mm to 0.1 mm.

2. The sound absorbing and insulating composite material composition of claim 1, formed by attaching a non-woven fiber layer and a polyethylene film closely, wherein the non-woven fiber layer is a stacked fiber layer manufactured by a non-woven fabric manufacturing method and has a thickness equal to or greater than 1 mm, and the polyethylene film has a thickness from 0.009 mm to 0.1 mm.

3. The sound absorbing and insulating composite material composition of claim 2, further comprising a second polyethylene film attached closely onto a surface of the non-woven fiber layer, and the second polyethylene film having a thickness from 0.009 mm to 0.1 mm.

4. The sound absorbing and insulating composite material composition of claim 3, further comprising a second non-woven fiber layer attached flatly and closely onto a surface of the second polyethylene film, and the second non-woven fiber layer being a stacked fiber layer manufactured by a non-woven fabric manufacturing method and having a thickness equal to or greater than 1 mm.

5. The sound absorbing and insulating composite material composition of claim 4, further comprising a third polyethylene film attached flatly and closely onto a surface of the second non-woven fiber layer, and the third polyethylene film having a thickness from 0.009 mm to 0.1 mm.

6. The sound absorbing and insulating composite material composition of claim 5, further comprising a third non-woven fiber layer attached flatly and closely onto a surface of the third polyethylene film, and the third non-woven fiber layer being a stacked fiber layer manufactured by a non-woven fabric manufacturing method and having a thickness equal to or greater than 1 mm.

7. The sound absorbing and insulating composite material composition of claim 6, further comprising a fourth polyethylene film attached flatly and closely onto a surface of the third non-woven fiber layer, and the fourth polyethylene film having a thickness from 0.009 mm to 0.1 mm.
